(19) United States
(12) Patent Application Publication
(10) Pub. No.: US 2018/0010705 A1
(43) Pub. Date: Jan. 11, 2018

(54) THROTTLE DEVICE AND REFRIGERATING CYCLE

(71) Applicant: Kabushiki Kaisha Saginomiya Seisakusho, Tokyo (JP)

(72) Inventors: Yasumasa Takada, Sayama-shi, Saitama (JP); Yuichiro Toyama, Sayama-shi, Saitama (JP); Shinpei Yagi, Sayama-shi, Saitama (JP); Junichi Yokota, Sayama-shi, Saitama (JP)

(21) Appl. No.: 15/546,677

(22) PCT Filed: Jan. 5, 2016
(86) PCT No.: PCT/JP2016/050150

§ 371 Date: Jul. 27, 2017

(30) Foreign Application Priority Data
Feb. 2, 2015 (JP) 2015-018634

(51) Int. Cl. F16K 17/30; F25B 41/06; F16K 47/04

(52) U.S. Cl. CPC F16K 17/30; F16K 47/04; F25B 41/062

(57) ABSTRACT

In a throttle device depressurizing and sending a refrigerant condensed by the condenser to the evaporator, hunting of a needle valve is prevented and hysteresis in differential pressure-flow rate characteristics in a high-pressure region is reduced. A valve seat member, in which a valve port is formed, and a cylindrical guide member, which is integral with the valve seat member, are provided in a cylindrical main body case configuring a primary chamber connected to the condenser and a secondary chamber connected to the evaporator. The needle valve and a coil spring energizing toward the valve port are provided in the guide member. A blade member is provided on a boss portion of the needle valve. A blade of the blade member abuts on a cylindrical guide surface of the guide member to apply sliding resistance.

### TECHNICAL FIELD

The present disclosure relates to a throttle device provided between a condenser and an evaporator in a refrigerating cycle, depressurizing and sending a refrigerant condensed by the condenser to the evaporator, and a refrigerating cycle using this throttle device.

### BACKGROUND ART

Conventionally, as this type of the throttle device, for example, JP 2008-138812 A (Patent Literature 1) is disclosed. A valve opening level of this conventional throttle device varies according to a differential pressure between a pressure of a refrigerant on a condenser side (primary side) and a pressure of the refrigerant on an evaporator side (secondary side).

### SUMMARY

### Technical Problem

Generally, in this type of the throttle device, the valve body is moved according to a differential pressure between a pressure of a refrigerant on a primary side and a pressure of the refrigerant on a secondary side. Therefore, at the beginning of the valve opening from the valve closing condition, due to the sharp decline of the pressure on the primary side, the valve body is moved in the valve closing direction. However, when the valve body is moved in the valve closing direction, the pressure on the primary side acting on the valve body is increased, and the valve body is moved in the valve opening direction again. In this way, at the beginning of the valve opening, the valve body repeats the valve opening and valve closing operations following the differential pressure change, and thereby the vibration of the valve body, namely, hunting is generated. There, for preventing the valve body from following the differential pressure change, it can be considered that a sliding resistance is given in between the valve body and a portion guiding the valve body. However, this sliding resistance generates a hysteresis in a differential pressure—flow rate characteristics, and this hysteresis becomes larger as the sliding resistance becomes larger (for further preventing the hunting).

An object of at least some implementations of the present invention is to prevent the hunting of the valve body and to reduce the hysteresis in the differential pressure—flow rate characteristics in the throttle device provided between a condenser and an evaporator in a refrigerating cycle, depressurizing and sending a refrigerant condensed by the condenser to the evaporator.

### Solution to Problem

According to a first aspect of at least some implementations of the present invention, there is provided a throttle device provided between a condenser and an evaporator in a refrigerating cycle to decompress and send a refrigerant condensed by the condenser to the evaporator, the throttle device including:

a main body case comprising a primary chamber connected to the condenser and a secondary chamber connected to the evaporator;

a valve seat member, in which a valve port is formed, arranged inside the main body case and in between the primary chamber and the secondary chamber;

a valve body to allow an opening level of the valve port to be variable by moving along an axial line of the valve port;

a guide surface parallel to the axial line of the valve port, and arranged in the secondary chamber side with respect to the valve seat member,

a spring member energizing the valve body toward the valve port;

an introduction channel as a gap between a side wall of the valve body and the guide surface, through which the refrigerant flows from the valve port side to a back-pressure chamber of the valve body; and

a blade member provided on one of the valve body and the guide surface, and applying sliding resistance between the other of the valve body and the guide surface and a blade of the blade member by abutting the blade on the other of the valve body and the guide surface,

wherein an end of the blade is provided at a downstream side of flow of the refrigerant flowing from the valve port side to the back-pressure chamber.

According to a second aspect of at least some implementations of the present invention, there is provided the throttle device as described in the first aspect, wherein the blade member is provided on the valve body, and the blade abuts on the guide surface to apply the sliding resistance between the guide surface and the blade.

According to a third aspect of at least some implementations of the present invention, there is provided the throttle device as described in the first aspect, wherein the blade member is provided on the guide surface, and the blade abuts on a side surface of the valve body to apply the sliding resistance between the valve body and the blade.

According to a fourth aspect of at least some implementations of the present invention, there is provided the throttle device as described in any one of the first to third aspects, wherein the end of the blade includes a curved surface portion having a point contact or a line contact with an object on which the blade abuts.

A refrigerating cycle wherein the throttle device described in any one of the first to fourth aspects is provided in between the condenser and the evaporator.

### Advantageous Effects of Invention

According to the first, second, third, and fifth aspects, due to the sliding resistance of the blade of the blade member, the hunting of the valve body is prevented in a low-pressure region at the beginning of the valve opening. Further, the end of the blade of the blade member is disposed in the downstream side with respect to the flow of the refrigerant flowing to the back-pressure chamber through the introduction channel, and this blade receives the fluid pressure of the refrigerant. Therefore, in a high-pressure region after the beginning of the valve opening, due to the fluid pressure of the refrigerant, the blade is displaced to reduce the sliding resistance. Therefore, the movement of the valve body follows the pressure change sensitively, and the hysteresis in the differential pressure-flow rate characteristics is reduced.

According to the fourth aspect, in addition to the effect of the first aspect, because the end of the blade includes a curved surface portion having a point contact or a line contact with an object on which the blade abuts, the sliding resistance between the object on which the blade abuts and the curved surface portion can be reduced in the high-pressure region, and the hysteresis in the differential pressure-flow rate characteristics can be further reduced.

### BRIEF DESCRIPTION OF DRAWINGS

FIGS. 1A, 1B and 1C are a vertical cross-sectional view, a bottom cross-sectional view, and a sectional view respectively, of a throttle device according to a first embodiment of the present invention.

FIGS. 2A and 2B are an enlarged view and a cross-sectional view, respectively, of FIG. 1.

FIGS. 3A, 3B, and 3C are a side view, a bottom view, and a perspective view respectively, of a blade member according to the first embodiment of the present invention.

FIG. 4 is a schematic diagram of a refrigerating cycle according to an embodiment of the present invention.

FIG. 5 is a graph illustrating one example of differential pressure-flow rate characteristics according to an embodiment of the present invention.

FIG. 6 is a vertical cross-sectional view of a throttle device according to a second embodiment of the present invention.

FIG. 7 is an enlarged view of the throttle device according to the second embodiment of the present invention.

FIGS. 8A and 8B are an enlarged view and a cross-sectional view respectively, of a modification example of the blade member according to an embodiment of the present invention.

### DESCRIPTION OF EMBODIMENTS

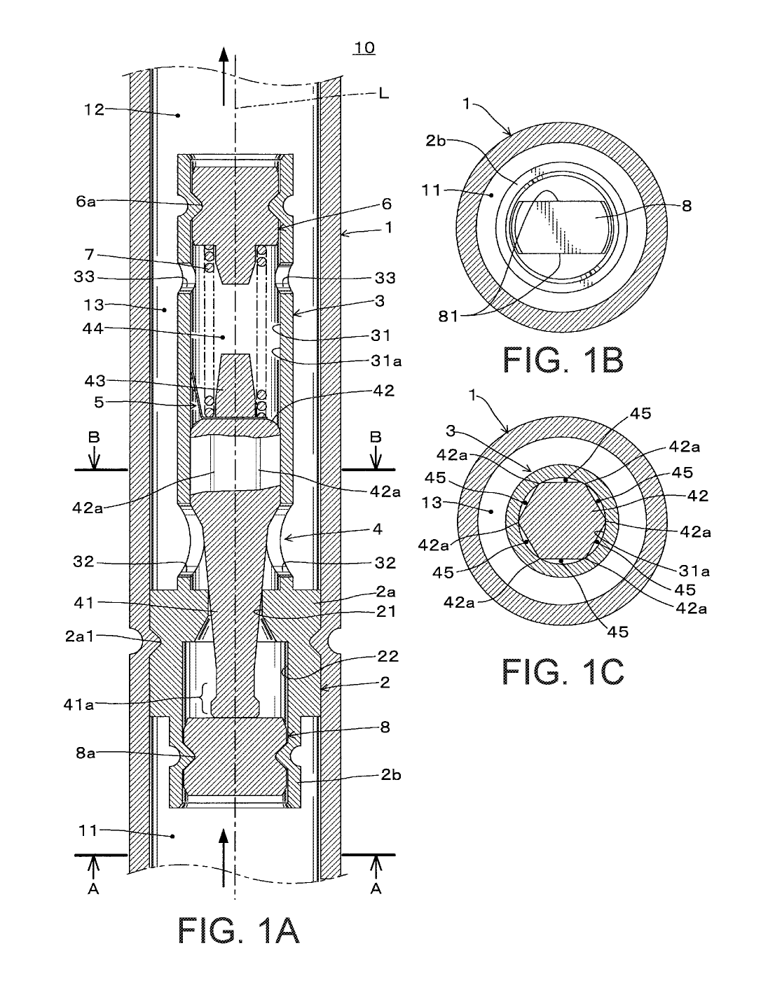

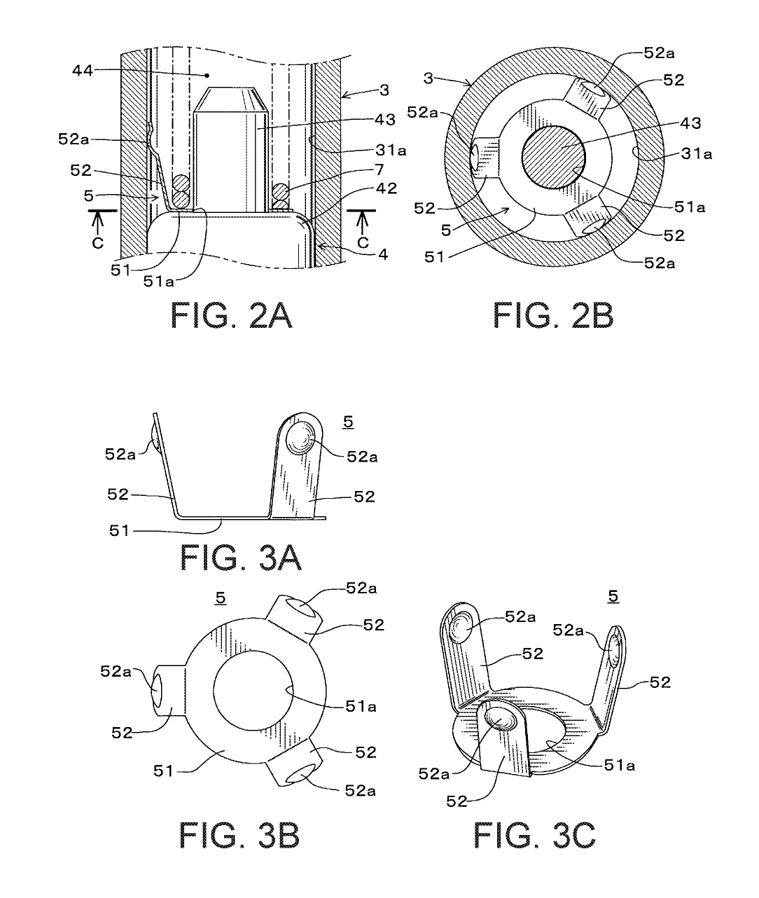

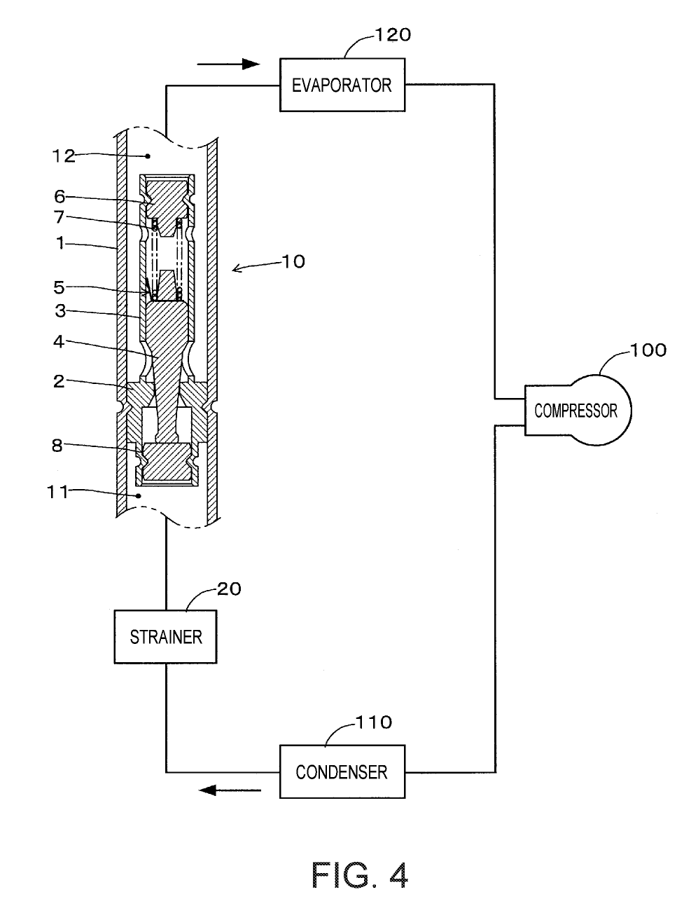

Next, embodiments of a throttle device will be described with reference to the drawings. FIG. 1A is a vertical cross-sectional view of a throttle device according to a first embodiment of the present invention. FIGS. 2A and 2B are an enlarged view and a cross-sectional view, respectively, of FIG. 1. FIG. 3A, 3B, and 3C are a side view, a bottom view, and a perspective view respectively, of a blade member according to the first embodiment of the present invention. FIG. 4 is a schematic diagram of a refrigerating cycle according to an embodiment of the present invention. Incidentally, FIG. 1B is an arrow view of A-A in FIG. 1A. FIG. 1C is a cross-sectional view taken on line B-B in FIG. 1A. FIG. 2B is an arrow view of C-C in FIG. 2A, and a coil spring is not shown.

First, the refrigerating cycle in FIG. 4 will be described. This refrigerating cycle configures an air conditioner for example and includes a compressor 100, a condenser 110, a throttle device 10 of the embodiment, a strainer 20, and an evaporator 120. A refrigerant compressed by the compressor 100 is supplied to the condenser 110, and the refrigerant condensed by the condenser 110 is delivered to the throttle device 10 via the strainer 20. The strainer 20 is for removing a foreign object included in the refrigerant flowing in the refrigeration cycle, and is a filter of, for example, about 80 to 100 mesh. The throttle device 10 expands and decompresses the refrigerant as described later and delivers the refrigerant to the evaporator 120. Then, when the refrigerating cycle is configured as an air conditioner, the evaporator 120 cools an inside of a room, thereby providing a function of air-cooling. The refrigerant evaporated by the evaporator 120 is circulated to the compressor 100.

As illustrated in FIGS. 1A to 1C, the throttle device 10 includes a main body case 1 of a metal tube, a valve seat member 2 made of a metal, a guide member 3, a needle valve 4 as a “valve body”, a blade member 5, a spring bearing 6, a coil spring as a “spring member”, and a stopper member 8. Incidentally, the valve seat member 2 and the guide member 3 are integrally formed by cutting a metal material or the like.

The main body case 1 has a cylindrical shape with an axial line L in the center thereof and includes a primary chamber 11 connected to the condenser 110 via the strainer 20 and a secondary chamber 12 connected to the evaporator 120. The valve seat member 2 is formed integrally by a substantially columnar shaped valve seat portion 2a that fits to an inner surface of the main body case 1, and a cylinder portion 2b extending downward from the valve seat portion 2a. The whole perimeter of an outer peripheral surface of the valve seat portion 2a (whole perimeter around the axial line L) is formed with a crimping groove 2a1. Crimping the main body case 1 at a position of the crimping groove 2a1 allows for fixing the valve seat member 2 (and the guide member 3) inside the main body case 1. This allows the valve seat member 2 to be arranged between the primary chamber 11 and the secondary chamber 12. Further, a valve port 21 as a cylindrical hole with an axial line L in the center thereof is formed in the valve seat member 2, and a large-diameter conduction chamber 22 conducting from the valve port 21 to an inside of the cylinder portion 2b is formed.

The guide member 3 has a cylindrical shape and stands on the valve seat member 2 in the secondary chamber 12. A space between this guide member 3 and the main body case 1 forms a main-body-side flow channel 13. The guide member 3 includes a cylindrical guide hole 31 having the axial line L in the center thereof and is formed with an open hole 32 connecting the guide hole 31 and the outside (secondary chamber 12) at a position adjacent to the valve seat member 2. Further, an inner peripheral surface of the guide hole 31 is a cylindrical guide surface 31a. This cylindrical guide surface 31a is parallel to the axial line L.

The needle valve 4 has a needle portion 41 of a conical shape with an end face of a tip portion 41a formed substantially flat, an insertion portion 42 to be inserted in the guide hole 31 of the guide member 3, and a boss portion 43 formed at an end portion of the insertion portion 42. As shown in FIG. 1C, a sectional shape of the insertion portion 42 on a surface perpendicular to the axial line L is substantially a hexagonal column shape, and a narrow surface between adjacent side surfaces of the hexagonal column of the insertion portion 42 is a guide portion 42a. Further, when the guide portion 42a slides along the cylindrical guide surface 31a of the guide hole 31, the needle valve 4 is guided to be moved along the axial line L. Further, a gap surrounded by the side surface of the hexagonal column of the insertion portion 42 and the cylindrical guide surface 31a of the guide hole 31 is an introduction channel 45 conducting from a space at the valve port 21 side to a back-pressure chamber 44 behind the needle valve 4.

As shown in FIGS. 2A to 3C, the blade member 5 is integrally formed by an annular fixture seat 51 having a fitting hole 51a and three blades 52 standing on an outer periphery of the fixture seat 51. A semispherical contact portion 52a as a “curved surface portion” bulging outward is formed on a tip of the blade 52. When the fitting hole 51a of the fixture seat 51 is fitted into the boss portion 43 of the needle valve 4, and further, the blade member 5 is energized by the coil spring 7, the blade member 5 is fixed to the needle valve 4. Then, the blade 52 of the blade member 5 pushes the semispherical contact portion 52a onto the cylindrical guide surface 31a of the guide hole 31 to contact slidingly the cylindrical guide surface 31a due to the elastic force of the blade 52. In this example, the semispherical contact portion 52a has a point contact with the cylindrical guide surface 31a. Thereby, the sliding resistance is applied between the cylindrical guide surface 31a and the blade 52.

The spring bearing 6 is substantially a cylinder shape, and the whole perimeter of an outer peripheral surface thereof (whole perimeter around the axial line L) is formed with a crimping groove 6a. Then, crimping the guide member 3 at a position of the crimping groove 6a allows for fixing the spring bearing 6 inside the guide member 3. The coil spring 7 is arranged in a compressed manner between the needle valve 4 and the spring bearing 6 via the blade member 5 in the guide hole 31.

The stopper member 8 has substantially a cylindrical shape, and as shown in FIG. 1B, D-cut surface 81 is formed on a side surface of the cylindrical stopper member 8. The primary chamber 11 conducts to the conduction chamber 22 of the valve seat member 2 via a gap between this D-cut surface 81 and the cylinder portion 2b. Further, an outer peripheral surface of the stopper member 8 other than the D-cut surface 81 (around the axial line L) is formed with a crimping groove 8a. Then, crimping the cylinder portion 2b of the valve seat member 2 at a position of the crimping groove 8a allows for fixing the stopper member 8 to the valve seat member 2.

In a state of FIGS. 1A to 1C, the tip portion 41a of the needle portion 41 of the needle valve 4 protrudes from the valve port 21 toward the primary chamber 11. An end face of the tip portion 41a of this needle portion 41 abuts on the stopper member 8. Incidentally, due to a position setting of the stopper member 8 in the axial line L direction with respect to the valve seat portion 2a, even when the end face of the tip portion 41a of this needle portion 41 abuts on the stopper member 8, a gap, namely “orifice” may be formed in between the needle portion 41 and the valve port 21.

With the above configuration, when the high pressure refrigerant from the condenser 110 flows into the primary chamber 11, the refrigerant in the primary chamber 11 travels through the gap between the stopper member 8 and the cylinder portion 2b, passes the gap (orifice) between the valve port 21 and the needle portion 41, and flows into the guide hole 31. The refrigerant flowed into the guide hole 31 is divided, and one of the divided refrigerant flows from the open hole 32 of the guide member 3 into the main-body-side flow channel 13 and the other of the divided refrigerant flows through the introduction channel 45 into the back-pressure chamber 44. The refrigerant in the main-body-side flow channel 13 directly flows into the secondary chamber 12 while the refrigerant in the back-pressure chamber 44 flows into the secondary chamber 12 via an upper open hole 33 of the guide member 3.

Because a sectional area of the introduction channel 45 surrounded by the needle valve 4 and the cylindrical guide surface 31a is large, the flow rate of the refrigerant can be increased. Therefore, a foreign substance mixed with the refrigerant flows through this introduction channel. Namely, a clearance in the introduction channel is set larger than a clearance (mesh size) of the strainer 20 in the refrigerating cycle. Therefore, a possibility that the foreign substance is caught by the clearance between the guide portion 42a of the side surface of the needle valve 4 and the cylindrical guide surface 31a of the guide member 3 can be reduced as much as possible. Therefore, there is no chance to lock the needle valve 4 with the foreign substance.

Further, with respect to the flow of the refrigerant flowing to the back-pressure chamber 44 via the introduction cannel 45, a base portion of the fixture seat 51 of the blade 52 of the blade member 5 is arranged at the upstream side, and the semispherical contact portion 52a is arranged to extend toward the downstream side. Thereby, the blade 52 receives the fluid pressure of the refrigerant. Here, in the low-pressure region at the beginning of the valve opening, because the valve opening level is low, the flow rate of the refrigerant is small and the fluid pressure received by the blade 52 is small. Therefore, due to the elastic force of the blade 52, an energizing force of the semispherical contact portion 52a against the cylindrical guide surface 31a is obtained sufficiently to increase the sliding resistance between the semispherical contact portion 52a and the cylindrical guide surface 31a. Therefore, in the low-pressure region at the beginning of the valve opening, the hunting of the needle valve 4 is prevented due to the sliding resistance.

In contrast, in the high-pressure region after the beginning of the valve opening, the valve opening level is high and the flow rate of the refrigerant becomes large, thereby the fluid pressure received by the blade 52 is high. This fluid pressure works to move the blade 52 (semispherical contact portion 52a) away from the cylindrical guide surface 31a. Therefore, the force energizing the semispherical contact portion 52a against the cylindrical guide surface 31a is reduced, and the sliding resistance between the semispherical contact portion 52a and the cylindrical guide surface 31a is reduced. Thereby, in the high-pressure region, the movement of the needle valve 4 follows the pressure change sensitively. Therefore, the hysteresis of the differential pressure-flow rate characteristics becomes small. Further, in this embodiment, because the semispherical contact portion 52a has a point contact with the cylindrical guide surface 31a, the sliding resistance is small, and the hysteresis of the differential pressure-flow rate characteristics becomes smaller. Incidentally, instead of the semispherical contact portion 52a, a vertically long domed “curved surface portion” may be used to abut on the cylindrical guide surface 31a. In this case, the vertically long domed curved surface portion may have a line contact with the cylindrical guide surface 31a.

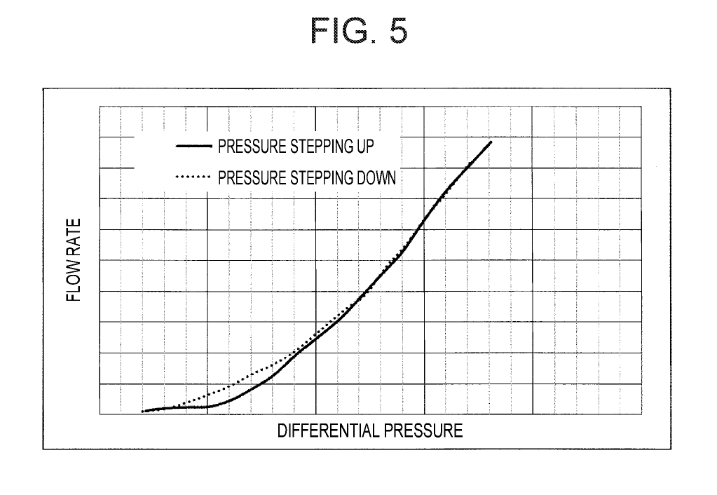

FIG. 5 is a graph showing an example of the differential pressure-flow rate characteristics according to this embodiment. The solid line indicates the flow rate upon pressure rising when the primary side pressure is increased, and the dashed line indicates the flow rate upon pressure down when the primary side pressure is decreased. As shown, in the low-pressure region (the region where the differential pressure is low), because the sliding resistance is large, a certain level of hysteresis exists. However, in the high-pressure region (the region where the differential pressure is high), the hysteresis hardly exists. Thereby, in the high-pressure region, the flow rate can be controlled well corresponding to the pressure, and the stable degree of superheat can be secured.

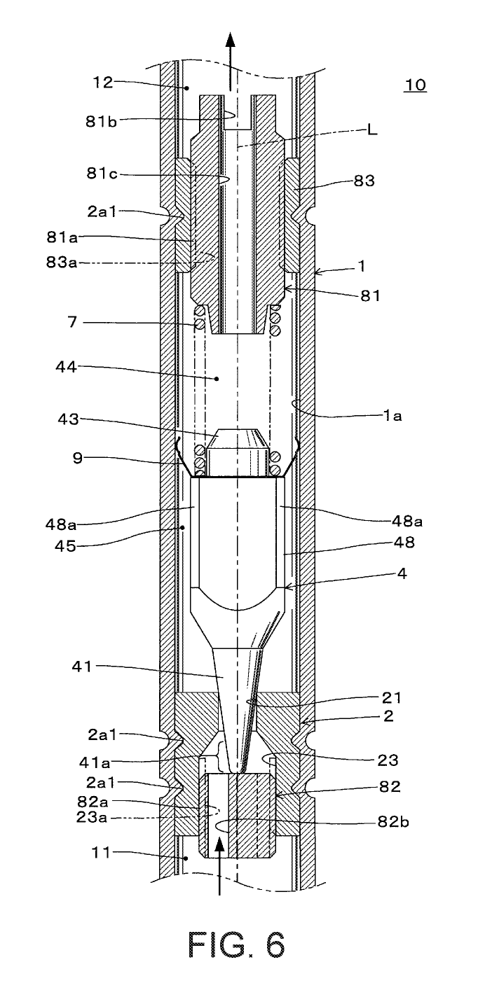

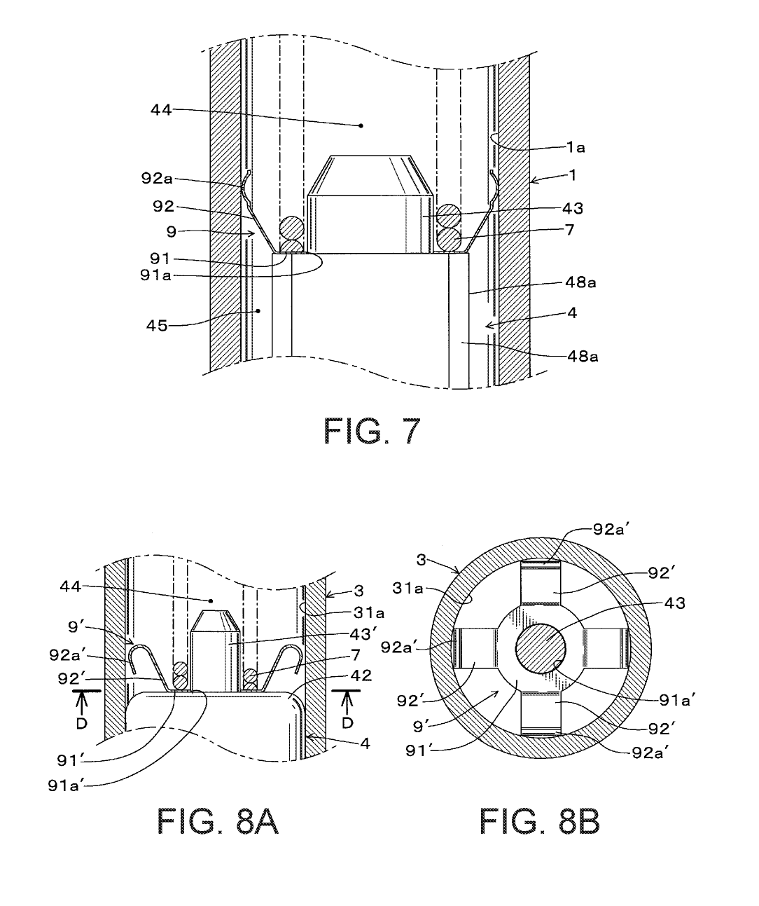

FIG. 6 is a vertical cross-sectional view of a throttle device according to a second embodiment of the present invention. FIG. 7 is an enlarged view of the throttle device according to the second embodiment of the present invention. The components similar to the first embodiment are denoted by the same reference signs as FIGS. 1 to 3, and the duplicate description is omitted. Further, the throttle device 10 of the second embodiment and provided on the refrigerating cycle of FIG. 4 is similar to that of the first embodiment.

In this throttle device 10 of the second embodiment, instead of the guide member 3 of the first embodiment, a main body case 1 guides the needle valve 4. As shown in FIG. 6, this throttle device 10 of the second embodiment includes a main body case 1 made of a metal pipe, a metallic valve seat member 2, a needle valve 4 as a “valve body”, an adjusting screw 81, a coil spring 7 as a “spring member”, and a stopper member 82.

The main body case 1 has a cylindrical shape with an axial line L in the center thereof and includes a primary chamber 11 connected to the condenser 110 via the strainer 120, and a secondary chamber 12 connected to the evaporator 120. Further, an inner peripheral surface of the main body case 1 is a cylindrical guide surface la. This cylindrical guide surface 1a is parallel to the axial line L.

The valve seat member 2 has a substantially columnar shape that fits to an inner surface of the main body case 1. The whole perimeter of an outer peripheral surface of the valve seat member 2 (whole perimeter around the axial line L) is formed with a crimping groove 2a1. Crimping the main body case 1 at a position of the crimping groove 2a1 allows for fixing the valve seat member 2 inside the main body case 1. This allows the valve seat member 2 to be arranged between the primary chamber 11 and the secondary chamber 12.

Furthermore, the valve seat member 2 is formed with a valve port 21, which has the axial line L in the center thereof and forms a columnar hole, and a screw hole 23 which is coaxial with the valve seat member 2 and opens from the valve port 21 toward the primary chamber 11. At an inner circumference of the screw hole 23, a female screw portion 23a is formed. The stopper member 82 has a substantially columnar shape and is formed with a male screw portion 82a at a circumference thereof. This stopper member 82 is further formed with three introduction holes 82b around the axial line L. Moreover, the stopper member 82 is attached to the valve seat member 2 with the male screw portion 82a at the circumference thereof screwed with the female screw portion 23a of the screw hole 23 of the valve seat member 2.

A female screw member 83 having a female screw portion 83a thereinside is arranged above an inside of the main body case 1. The whole perimeter of an outer peripheral surface of the female screw member 83 (whole perimeter around the axial line L) is formed with a crimping groove 2a1. Crimping the main body case 1 at a position of the crimping groove 2a1 allows for fixing the female screw member 83 inside the main body case 1. The adjusting screw 81 is formed with a male screw portion 81a at a circumference thereof as well as a slit 81b, to which a flat tip screwdriver can be fitted, at an end portion on the secondary chamber 12 side. The adjusting screw 81 is further formed with a through hole 81c in the center thereof in a penetrating manner. The coil spring 7 is arranged in a compressed manner between the needle valve 4 and the adjusting screw 81 via the blade member 9 inside the main body case 1. Moreover, the adjusting screw 81 is attached to the female screw member 83 with the male screw portion 81a at the circumference thereof screwed with the female screw portion 83a of the female screw member 83. This allows the coil spring 7 to energize the needle valve 4 toward the primary chamber 11. This energizing force to energize the needle valve 4 is adjusted by a degree how much the adjusting screw 81 is screwed with the female screw member 83.

The needle valve 4 of this second embodiment has a needle portion 41 of a conical shape similar to the first embodiment, an insertion portion 48 to be inserted in the cylindrical guide surface 1a of the main body case 1, and a boss portion 43 formed at an end portion of the insertion portion 48. This insertion portion 48 has a shape that four side surface of the columnar body are D-cut, and a surface between D-cut surfaces is a guide portion 48a. Further, when the guide portion 48a slides along the cylindrical guide surface 1a of the main body case 1, the needle valve 4 is guided to be moved along the axial line L. Further, a space surrounded by the side surface of the square column of the insertion portion 48 and the cylindrical guide surface 1a is an introduction channel 45 conducting from a space at the valve port 21 side to a back-pressure chamber 44.

Incidentally, in this second embodiment, the tip portion 41a of the needle portion 41 (position of an end portion of the valve body on the primary chamber side) is positioned by the stopper member 82. Further, a flow rate of the refrigerant flowing in this orifice, namely a bleed rate, can be adjusted by a degree how much the stopper member 82 is screwed with the valve seat member 2. In this manner, the bleed rate can be adjusted by a degree of screwing and thus can be adjusted extremely accurately. After adjusting a position of the stopper member 82, the stopper member 82 is fixed to the valve seat member 2 by, for example bonding, brazing, crimping, or the like.

The blade member 9 is integrally formed by an annular fixture seat 91 having a fitting hole 91a and four blades 92 standing on an outer periphery of the fixture seat 91. A semispherical contact portion 92a as a “curved surface portion” bulging outward is formed on a tip of the blade 92. When the fitting hole 91a of the fixture seat 91 is fitted into the boss portion 43 of the needle valve 4, and further, the blade member 9 is energized by the coil spring 7, the blade member 9 is fixed to the needle valve 4. Then, the blade 92 of the blade member 9 pushes the semispherical contact portion 92a onto the cylindrical guide surface 1a of the main body case 1 to contact slidingly the cylindrical guide surface 1a due to the elastic force of the blade 92.

In this second embodiment also, with respect to the flow of the refrigerant flowing to the back-pressure chamber 44 via the introduction cannel 45, a base portion of the fixture seat 91 of the blade 92 of the blade member 9 is arranged at the upstream side, and the semispherical contact portion 92a is arranged to extend toward the downstream side. Thereby, the blade 92 receives the fluid pressure of the refrigerant. Then, similar to the first embodiment, in the low-pressure region at the beginning of the valve opening, because the valve opening level is low, the flow rate of the refrigerant is small and the fluid pressure received by the blade 92 is small. Therefore, due to the elastic force of the blade 92, an energizing force of the semispherical contact portion 92a against the cylindrical guide surface 1a is obtained sufficiently to increase the sliding resistance between the semispherical contact portion 92a and the cylindrical guide surface 1a. Therefore, in the low-pressure region at the beginning of the valve opening, the hunting of the needle valve 4 is prevented due to the sliding resistance.

In contrast, in the high-pressure region after the beginning of the valve opening, the valve opening level is high and the flow rate of the refrigerant becomes large, thereby the fluid pressure received by the blade 92 is high. This fluid pressure works to move the blade 92 (semispherical contact portion 92a) away from the cylindrical guide surface 1a. Therefore, the force energizing the semispherical contact portion 92a against the cylindrical guide surface 1a is reduced, and the sliding resistance between the semispherical contact portion 92a and the cylindrical guide surface 1a is reduced. Thereby, in the high-pressure region, the movement of the needle valve 4 follows the pressure change sensitively. Therefore, the hysteresis of the differential pressure-flow rate characteristics becomes small.

FIGS. 8A and 8B show a modification example of the blade member. FIG. 8B is an arrow view of D-D in FIG. 8A, and an illustration of the coil spring is omitted. The blade member 9′ is integrally formed by an annular fixture seat 91′ having a fitting hole 91a′ and four blades 92′ standing on an outer periphery of the fixture seat 91′. In this modification example, a curve portion 92a′ as a “curved surface portion” bulging outward is formed on a tip of the blade 92′. When the fitting hole 91a′ of the fixture seat 91′ is fitted into the boss portion 43′ of the needle valve 4, and further, the blade member 9′ is energized by the coil spring 7, the blade member 9′ is fixed to the needle valve 4. Incidentally, in this modification example, the radius of the boss portion 43′ is smaller than the first embodiment. That is for arranging the base of the blade 92′ further inside than the first embodiment. Then, the blade 92 of the blade member 9 pushes the curved portion 92a′ onto the cylindrical guide surface 31a of the guide member 3 to contact slidingly the cylindrical guide surface 31a due to the elastic force of the blade 92. The curved portion 92a′ has two point contacts with the cylindrical guide surface 31a. In this modification example also, similar to the first and second embodiments, the hunting of the needle valve 4 can be prevented, and the hysteresis in the differential pressure-flow rate characteristics can be reduced.

The throttle device according to the above embodiments and the modification example is a throttle device in which a diameter of the valve port 21 is about 1 mmφ to 2.5 mmφ. Further, according to the first embodiment and the modification example in which the needle valve 4 is inserted in the guide member 3, the flow rate of the refrigerant in the introduction channel 45 is smaller than that in the main-body-side flow channel 13 in a gap between the guide member 3 and the main body case 1. Therefore, due to the liquid flow, the blade 52, 92′ of the blade member 5, 9′ do not vibrate themselves to make noise. Further, in the first embodiment and the modification example, the insertion portion 42 of the needle valve 4 is in a hexagonal column shape, and a clearance of the introduction channel 45 (clearance between the guide member 3 and the insertion portion 42) is about 1.5 mm. This insertion portion 42 can be in a square column, and in this case, the clearance of the introduction channel 45 is about 0.35 mm. In contrast, the thicknesses of the blades 52, 92′ are about 0.05 to 0.1 mm. In this way, because the thicknesses of the blades 52, 92′ are thinner than the clearance of the introduction channel 45, even if the flow rate in the introduction channel 45 is small, the blades 52, 92′ sensitively respond to the flow, and the hysteresis in the differential pressure-flow rate characteristics can be easily changed.

In the embodiments and the modification example above, a case that the blade member is fixed to the needle valve 4 side is described. However, a similar blade member may be provided on the cylindrical guide surface (guide surface) side. In this case also, a base of the blade is arranged upstream side of the fluid, and an end of the blade is arranged downstream side of the fluid to receive the fluid pressure of the refrigerant flowing to the back-pressure chamber with respect to the needle valve. Further, the end of the blade pushes a side surface of the needle valve (valve body) to contact slidingly the side surface of the needle valve. Thereby, in the low-pressure region at the beginning of the valve opening, while the fluid pressure received by the blade is small, the sliding resistance between the needle valve and the blade due to the elastic force of the blade is increased to prevent the hunting of the needle valve. Further, in the high-pressure region, the fluid pressure of the refrigerant with a lot of flow rate is received by the blade to move the end of the blade away from the side surface of the needle valve and to reduce the sliding resistance between the end of the blade and the needle valve. Thereby, in the high-pressure region, the movement of the needle valve follows the pressure change sensitively, and the hysteresis in the differential pressure-flow rate characteristics is reduced.

The embodiments of the present invention have been described above in detail with reference to the drawings. However, specific configurations are not limited to these embodiments and those with modifications or the like of a design within a scope not departing from the principal of the present invention are also included in the present invention. An example in which the guide surface to guide the needle valve is in a cylindrical shape is described. However, for example, the guide surface may be a rectangular column shape parallel to the axial line, the cylindrical insertion portion of the needle portion may be inserted thereinside, and the rectangular column shaped guide surface may guide an outer periphery of the insertion portion.

1. A throttle device provided between a condenser and an evaporator in a refrigerating cycle to decompress and send a refrigerant condensed by the condenser to the evaporator, the throttle device comprising:
a main body case comprising a primary chamber connected to the condenser and a secondary chamber connected to the evaporator;
a valve seat member, in which a valve port is formed, arranged inside the main body case and in between the primary chamber and the secondary chamber;
a valve body to allow an opening level of the valve port to be variable by moving along an axial line of the valve port;
a guide surface parallel to the axial line of the valve port, and arranged in the secondary chamber side with respect to the valve seat member,
a spring member energizing the valve body toward the valve port;
an introduction channel as a gap between a side wall of the valve body and the guide surface, through which the refrigerant flows from the valve port side to a back-pressure chamber of the valve body; and
a blade member provided on one of the valve body and the guide surface, and applying sliding resistance between the other of the valve body and the guide surface and a blade of the blade member by abutting the blade on the other of the valve body and the guide surface,
wherein an end of the blade is provided at a downstream side of flow of the refrigerant flowing from the valve port side to the back-pressure chamber.

2. The throttle device as claimed in claim 1,
wherein the blade member is provided on the valve body, and the blade abuts on the guide surface to apply the sliding resistance between the guide surface and the blade.

3. The throttle device as claimed in claim 1,
wherein the blade member is provided on the guide surface, and the blade abuts on a side surface of the valve body to apply the sliding resistance between the valve body and the blade.

4. The throttle device as claimed in claim 1,
wherein the end of the blade includes a curved surface portion having a point contact or a line contact with an object on which the blade abuts.

5. A refrigerating cycle wherein the throttle device claimed in claim 1 is provided in between the condenser and the evaporator.

6. The throttle device as claimed in claim 2, wherein the end of the blade includes a curved surface portion having a point contact or a line contact with an object on which the blade abuts.

7. The throttle device as claimed in claim 3, wherein the end of the blade includes a curved surface portion having a point contact or a line contact with an object on which the blade abuts.

8. A refrigerating cycle wherein the throttle device claimed in claim 2 is provided in between the condenser and the evaporator.

9. A refrigerating cycle wherein the throttle device claimed in claim 3 is provided in between the condenser and the evaporator.

10. A refrigerating cycle wherein the throttle device claimed in claim 4 is provided in between the condenser and the evaporator.
